(19) United States
(12) Patent Application Publication
(10) Pub. No.: US 2025/0125765 A1
(43) Pub. Date: Apr. 17, 2025

(54) Outdoor Mounted Solar Panels Cleaning System and Method Thereof

(71) Applicant: Martin Martinez, Porterville, CA (US)

(72) Inventor: Martin Martinez, Porterville, CA (US)

(21) Appl. No.: 18/739,837

(22) Filed: Jun. 11, 2024

Related U.S. Application Data
(60) Provisional application No. 63/590,500, filed on Oct. 16, 2023.

(51) Int. Cl. H02S 40/10

(52) U.S. Cl. CPC H02S 40/10

(57) ABSTRACT

A solar panel cleaning system designed for efficient and effective removal of debris such as dust, dirt, insects, and leaves from solar panels is disclosed. The system includes a longitudinal spray bar and is equipped with a plurality of nozzles. The nozzles can be equidistantly positioned or varied in distance for cleaning solar panels of different sizes. A central nozzle in the spray bar regulates the water flow, which can be connected to an external water supply. For removably mounting the system, installation units are used for secure mounting of the system. The system can be controlled remotely using a mobile application for activation and scheduled activation of the system.

### CROSS-REFERENCE TO RELATED APPLICATION

The present application claims priority to, and the benefit of, U.S. Provisional Application No. 63/590,500, which was filed on Oct. 16, 2023, and is incorporated herein by reference in its entirety.

### FIELD OF THE INVENTION

The present invention generally relates to the field of systems and methods for solar panel cleaning. More specifically, the present invention relates to a novel solar panel cleaning system for cleaning solar panels mounted on a roof or other areas. The system includes a spray bar that supports multiple nozzles in a horizontal configuration, positioned so that water is dispensed across the solar panel face to prevent leaves, dirt, dust, insects, and other debris from contaminating and/or damaging the solar panels. The spray bar can be connected to a water source and selectively activated to spray water across the face of the solar panels for cleaning. Accordingly, the present disclosure makes specific reference thereto. Nonetheless, it is to be appreciated that aspects of the present invention are also equally applicable to other like applications, devices, and methods of manufacture.

### BACKGROUND

By way of background, in the last few years, the adoption of rooftop solar panels for renewable electricity generation has increased significantly. In some countries, government subsidies are also provided to help offset the initial installation costs of the solar panels. Solar panels work by converting sunlight into electricity, which is a clean and renewable source of energy. Solar panels, also known as photovoltaic (PV) panels, are made up of multiple solar cells. The cells are connected to form a solar panel, and several panels are linked to create a solar array.

When solar panels such as in the form of arrays are installed on rooftops of homes and buildings; dust, dirt, insects, and other debris can accumulate on the surface of solar panels. Accumulation of foreign materials can significantly reduce the efficiency of the solar panels, as foreign materials block sunlight from reaching the solar cells. Accordingly, solar panels produce less electricity, reducing the return on investment. Furthermore, the foreign materials decrease the operating life of the solar panels.

Keeping solar panels installed on rooftops and other outdoor areas clean is necessary to maintain their efficiency, but accessing the solar panels is challenging. Cleaning solar panels often requires specialized equipment and can be dangerous due to the risk of falls or electrical hazards. Hiring professionals to clean solar panels can be expensive and time-consuming. Further, accessing rooftop solar panels for maintenance or repair can be hazardous and requires ladders or other equipment, and poses a risk of falls.

While rooftop solar panels offer a sustainable and increasingly affordable way to generate electricity, their efficiency is compromised by the accumulation of dust and debris. People desire a comprehensive cleaning system for solar panels mounted on a roof or other areas that does not require manual effort and is safe.

Therefore, there exists a long-felt need in the art for a solar panel cleaning system that easily cleans and maintains the solar panel system. Additionally, there is a long-felt need in the art for a comprehensive cleaning system for solar panels mounted on a roof or other areas. Moreover, there is a long-felt need in the art for a cleaning system that uses water to clean roof mounted solar panels. Further, there is a long-felt need in the art for a solar panel cleaning system that includes multiple nozzles to dispense water across the solar panel face. Furthermore, there is a long-felt need in the art for a solar panel cleaning system that can be mounted to a roof or other area to dispense water on the solar panels for removing debris and dirt. Also, there is a long-felt need in the art for an innovative and user-friendly solar panel cleaning system that eliminates manual effort, use of ladders, and other equipment to reach rooftop solar panels for cleaning. Finally, there is a long-felt need in the art for a comprehensive solar panel cleaning system that prevents leaves, dirt, dust, insects, and other debris from contaminating and/or damaging the solar panels, thereby maintaining efficiency and increasing the life of the solar panels.

The subject matter disclosed and claimed herein, in one embodiment thereof, comprises a solar panel cleaning system. The solar panel cleaning system cleans the rooftop solar panels and prevents leaves, dirt, dust, insects, and other debris from contaminating and/or damaging the solar panels. The system includes a longitudinal spray bar that extends between a first end and a second end, the spray bar is connectable to an external water supply and is positioned above the solar panels. A plurality of spray nozzles are positioned along the length of the spray bar. Each nozzle is designed to spray water across the face of solar panels for removing debris such as dust, dirt, insects, and leaves from the solar panels. A central water nozzle is installed in the system for selectively enabling the flow of water along the spray bar for dispensing through the nozzles. The system can be removably mounted using mountable connectors on a roof or any other area to clean the solar panels.

In this manner, the solar panels cleaning system of the present invention accomplishes all of the foregoing objectives and provides users with a comprehensive cleaning system for solar panels mounted on a roof or other areas. The system includes a spray bar that includes multiple nozzles in a horizontal configuration, positioned to dispense water across the solar panel surface. The system prevents leaves, dirt, dust, insects, and other debris from contaminating and/or damaging the solar panels. Users can connect the spray bar to a water source and selectively activate using a nozzle to spray water across the face of the solar panels for cleaning. The system eliminates manual effort, manpower, and costs associated with the cleaning of solar panels.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar panel cleaning system. The system comprises a removably mounted longitudinal spray bar that extends between a first end and a second end, the spray bar is connectable to an external water supply. A plurality of spray nozzles are positioned along the length of the spray bar. Each nozzle is designed to spray water across the face of solar panels for removing debris such as dust, dirt, insects, and leaves from the solar panels. A central water nozzle is installed in the system for selectively enabling the flow of water along the spray bar for dispensing through the nozzles.

In another aspect, the nozzles are equidistantly positioned along the spray bar, ensuring uniform distribution of water across the solar panels, and alternatively can be positioned at varying distances from each other along the spray bar.

In yet another embodiment, the spray bar is constructed of schedule 40 PVC pipe, providing durability, weatherproofing, chemical resistance, and corrosion resistance.

In yet another aspect of the present invention, each nozzle is adjustable and provides either a mist or a direct stream of water.

In a further embodiment of the present invention, a solar panel cleaning system is disclosed. The device includes a longitudinal spray bar equipped with a plurality of nozzles for dispensing water onto one or more solar panels. One or more installation units are configured to securely mount the spray bar in a substantially horizontal position above the top surface of the target solar panels, wherein the installation units are designed for removable installation on a roof or other areas where the solar panels are located, using mechanical fasteners such as screws or bolts. A central nozzle activates the flow of water along the spray bar, enabling the water to be dispensed from the nozzles to clean the solar panels.

In yet another aspect, each nozzle includes a rotating member that is adapted to be rotated in a first direction to create a fine mist spray and can be rotated in an opposite direction to create a directed stream of water.

In another example, the solar panels cleaning system can be coupled with a companion mobile application for remotely controlling the system. The application provides an interface for displaying a control for enabling a user to remotely activate the flow of water through the spray bar and the nozzles. A second option is provided to schedule the activation/deactivation of the flow of water in the system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the solar panels cleaning system of the present invention in accordance with the disclosed structure;

FIG. 2 illustrates a perspective view showing the solar panels cleaning system connected to an external water source for water supply in accordance with one embodiment of the present invention;

FIG. 3 illustrates a perspective view showing the solar panels cleaning system of the present invention installed to clean the solar panels in accordance with the disclosed structure;

FIG. 4 illustrates an isolated view of an exemplary nozzle used in the solar panels cleaning system of the present invention in accordance with one embodiment of the present invention; and

FIG. 5 illustrates an exemplary user interface displayed by a mobile application coupled with the solar panels cleaning system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a solar panel cleaning system that easily cleans and maintains the solar panel system. Additionally, there is a long-felt need in the art for a comprehensive cleaning system for solar panels mounted on a roof or other areas. Moreover, there is a long-felt need in the art for a cleaning system that uses water to clean roof mounted solar panels. Further, there is a long-felt need in the art for a solar panel cleaning system that includes multiple nozzles to dispense water across the solar panel face. Furthermore, there is a long-felt need in the art for a solar panel cleaning system that can be mounted to a roof or other area to dispense water on the solar panels for removing debris and dirt. Also, there is a long-felt need in the art for an innovative and user-friendly solar panel cleaning system that eliminates manual effort, use of ladders, and other equipment to reach rooftop solar panels for cleaning. Finally, there is a long-felt need in the art for a comprehensive solar panel cleaning system that prevents leaves, dirt, dust, insects, and other debris from contaminating and/or damaging the solar panels, thereby maintaining efficiency and increasing the life of the solar panels.

The present invention, in one exemplary embodiment, is a solar panel cleaning system. The system includes a longitudinal spray bar equipped with a plurality of nozzles for dispensing water onto one or more solar panels. One or more installation units are configured to securely mount the spray bar in a substantially horizontal position above the top surface of the target solar panels, wherein the installation units are designed for removable installation on a roof or other areas where the solar panels are located, using mechanical fasteners such as screws or bolts. A central nozzle activates the flow of water along the spray bar, enabling the water to be dispensed from the nozzles to clean the solar panels.

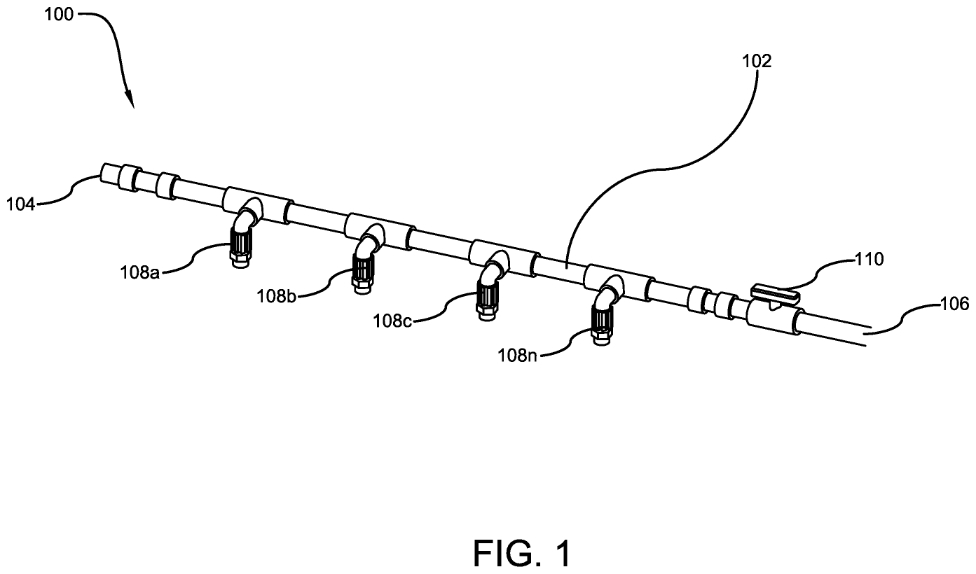

Referring initially to the drawings, FIG. 1 illustrates a perspective view of the solar panels cleaning system of the present invention in accordance with the disclosed structure. The solar panels cleaning system 100 of the present invention is designed to effectively remove unwanted debris such as dust, dirt, insects, leaves, and more from the surface of the solar panels mounted on roofs and other areas. The solar panels cleaning system 100 can come in different sizes to meet the cleaning requirements of different sizes of solar panels. More specifically, the rinse and clean system 100 is removably mounted on an area to clean solar panels. The cleaning system 100 includes a longitudinal spray bar 102 extending between a first end 104 and a second end 106 which is opposite to the first end 104.

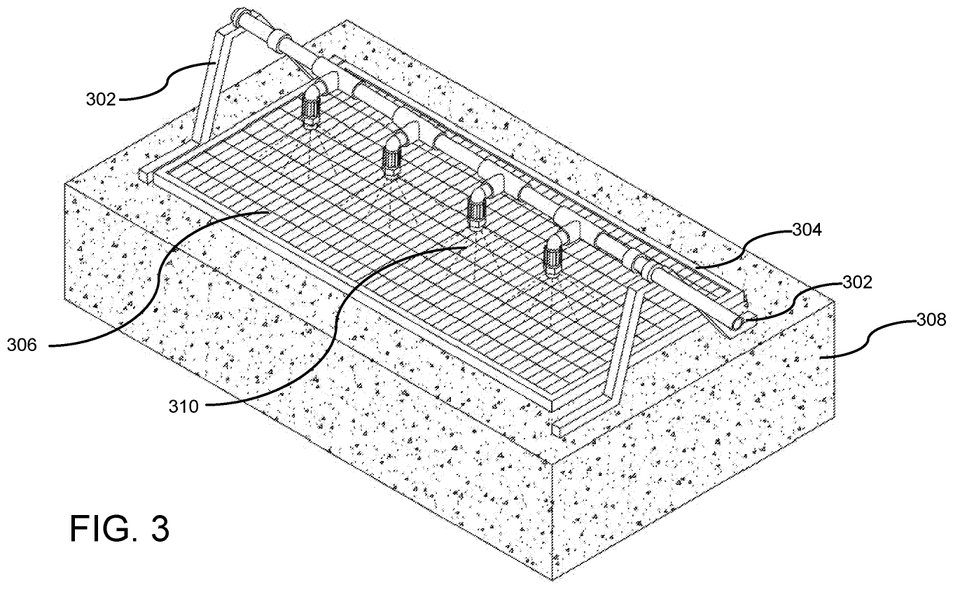

The spray bar 102 includes a plurality of spray nozzles 108a-n (hereinafter, referred to as 108) positioned along the length of the spray bar 102. Each nozzle 108 is designed to spray water on the solar panels as illustrated in FIG. 3. Each nozzle 108 can be the same or different and is used for spraying water across the face of the solar panels. In one embodiment, the nozzles 108 are equidistant from each other, and in other embodiments, the nozzles 108 can be positioned at different distances from each other.

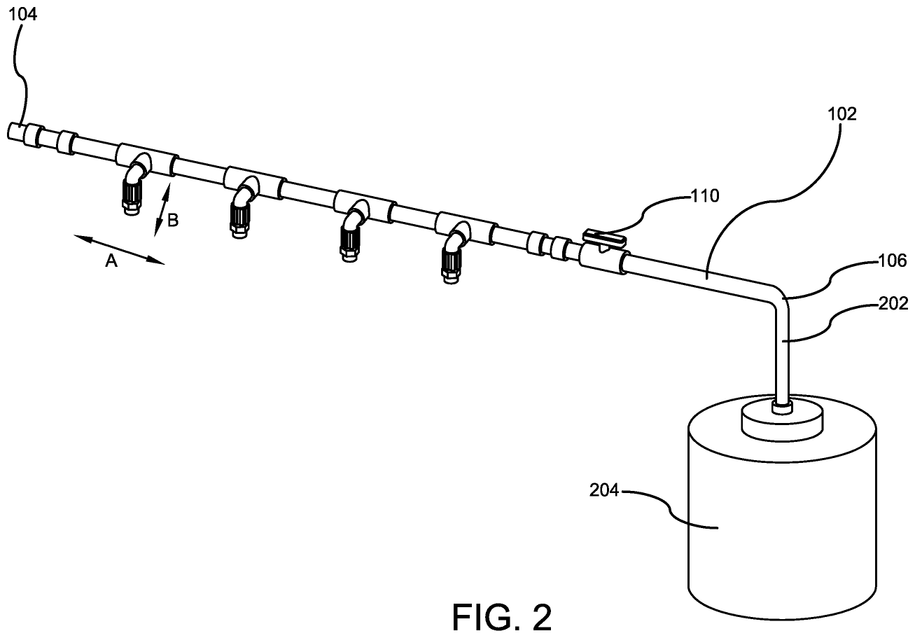

A central water nozzle control 110 is installed in the system 100 for selectively enabling a flow of water along the spray bar 102 for dispensing through the nozzles 108. The spray bar 102 can be connected to any external water supply as illustrated in FIG. 2 enabling users to use the cleaning system 100 in residential areas and larger solar farms. The spray bar 102 is preferably a schedule 40 PVC pipe. Further, the spray bar 102 is durable, weatherproof, chemical resistant, and corrosion resistant.

FIG. 2 illustrates a perspective view showing the solar panels cleaning system connected to an external water source for water supply in accordance with one embodiment of the present invention. As illustrated, the second end 106 is connected to hose 202 of a water source 204. The water supply is selectively activated using the central water nozzle control 110 for dispensing water through the nozzles 108. The water source 204 can be any water source such as a water tank, water hose, central water supply, and more.

In some embodiments, the nozzles 108 can be adjustable both laterally (Arrow A) or relative (Arrow B) to the spray bar 102. The adjustable nozzles can provide a wider coverage of water spray on the surface of solar panels.

FIG. 3 illustrates a perspective view showing the solar panels cleaning system of the present invention installed to clean the solar panels in accordance with the disclosed structure. The cleaning system 100 is installed using one or more installation units or at least a pair of mounting legs 302 which are compatible with the system 100 and are used for securing the spray bar 102 in a substantially horizontal position over (i.e., elevated above) the top surface 306 of the target solar panels 304. The installation units 302 preferably come along with the cleaning system 100 in the form of a kit.

The installation units 302 are installed on the roof 308 or any other area where the solar panels 304 to be cleaned are installed. The installation units 302 can be removably installed using mechanical fasteners (not shown) such as screws, bolts, and more. The spray bar 102 along with the connected nozzles 108 is secured to the installation units 302 such that the nozzles 108 direct towards the top surface 306 of the solar panels 304. The directed stream or mist 310 from the nozzles 108 run down the top surface 306 of the solar panels 304 to clean foreign materials.

For cleaning the solar panels 304, the central nozzle control 110 is turned on to activate the flow of water along the spray bar 102, and the water is dispensed from the nozzles 108 to clean the solar panels 304 easily and effectively. The system 100 potentially reduces the need for professional cleaning services, thereby saving costs over the long term, and improves the efficiency of solar panels, ensuring optimal energy production and return on investment.

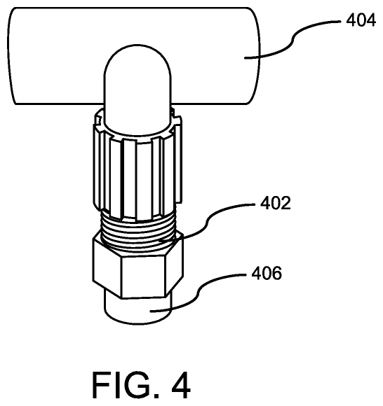

FIG. 4 illustrates an isolated view of an exemplary nozzle used in the solar panels cleaning system of the present invention in accordance with one embodiment of the present invention. The nozzles used in the cleaning system 100 provides a directed and uniform mist or direct stream. The rotating member 402 can be rotated clockwise to create a fine mist spray and can be rotated counterclockwise to create a directed stream of water. The top connecting member or sleeve 404 is used for removably attaching the nozzle to the spray bar 102 and provides a secure fit for preventing any leakages.

The dispensing member 406 is adjustable and can be adjusted laterally to adjust direction of the spray from the nozzle. A filter (not illustrated) can be inserted between the water source 204 and the spray bar 102 to filter any dirt and debris in the water and to provide an effective and clean stream of water to the top surface of the solar panels.

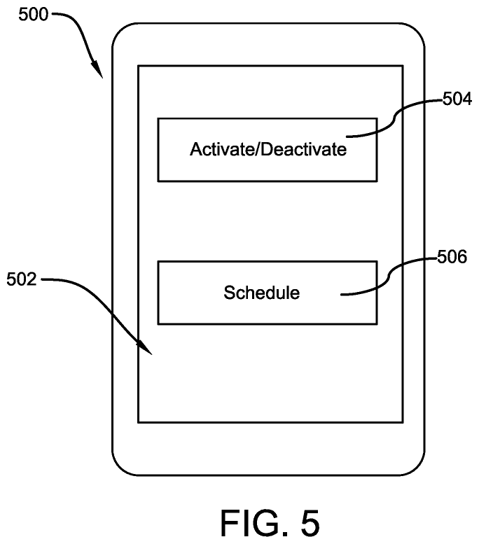

FIG. 5 illustrates an exemplary user interface displayed by a mobile application coupled with the solar panels cleaning system of the present invention in accordance with the disclosed structure. In the present embodiment, the system 100 can be coupled with a companion mobile application 500 for remotely controlling the system 100. The interface 502 of the application 500 displays Activate/Deactivate option 504 for enabling a user to remotely activate the flow of water through the spray bar 102 and the nozzles 108. A schedule option 506 allows a user to schedule the activation/deactivation of the flow of water in the system 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar panels cleaning system”, “rinse and clean system”, “cleaning system”, “solar array comprehensive cleaning system”, and “system” are interchangeable and refer to the solar array comprehensive cleaning system 100 of the present invention.

Notwithstanding the foregoing, the solar array comprehensive cleaning system 100 of the present invention can be of any suitable size and configuration as is known in the art without affecting the overall concept of the invention, provided that it accomplishes the above-stated objectives. One of ordinary skill in the art will appreciate that the solar array comprehensive cleaning system 100 as shown in the FIGS. is for illustrative purposes only, and that many other sizes and shapes of the solar array comprehensive cleaning system 100 are well within the scope of the present disclosure. Although the dimensions of the solar array comprehensive cleaning system 100 are important design parameters for user convenience, the solar array comprehensive cleaning system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar panel cleaning system comprising:
a longitudinal spray bar extending between a first end and an opposing second end;
a plurality of spray nozzles;
a water nozzle control;
an installation unit;
a water supply; and
a hose;
wherein said plurality of spray nozzles are positioned along said longitudinal spray bar;
wherein said hose connecting said water supply to said longitudinal spray bar;
wherein said installation unit having at least a pair of mounting legs for mounting said longitudinal spray bar and said plurality of spray nozzles elevated above the solar panels;
wherein each of said plurality of spray nozzles having a selectable spray nozzle;
wherein said selectable spray nozzle selectable from a spray mist of water and a spray stream of water; and
further wherein said water nozzle control in said enabled orientation flows water to said longitudinal spray bar and said plurality of spray nozzles for spraying water over the solar panels.

2. The solar panel cleaning system of claim 1, wherein said longitudinal spray bar having a material of a schedule 40 PVC pipe.

3. The solar panel cleaning system of claim 1, wherein said plurality of spray nozzles are equidistant from each other.

4. The solar panel cleaning system of claim 1, wherein each of said plurality of spray nozzles selectively positionable laterally along said longitudinal spray bar.

5. The solar panel cleaning system of claim 4, wherein each of said plurality of spray nozzles selectively positionable to an orthogonal distance relative to said longitudinal spray bar.

6. The solar panel cleaning system of claim 5, wherein said water nozzle control selectively positioned between an enabled orientation to allow water flow to said plurality of spray nozzles, and a disabled orientation to prevent water flow to said plurality of spray nozzles.

7. The solar panel cleaning system of claim 6, wherein each of said plurality of spray nozzles having a mounting sleeve for slidable positioning along said longitudinal spray bar.

8. A solar panel cleaning system comprising:
a longitudinal spray bar extending between a first end and an opposing second end;
a plurality of spray nozzles;
a water nozzle control;
an installation unit;
a water supply; and
a hose;
wherein said plurality of spray nozzles are positioned along said longitudinal spray bar;
wherein said hose connecting said water supply to said longitudinal spray bar;
wherein said water nozzle control selectively positioned between an enabled orientation to allow water flow to said plurality of spray nozzles, and a disabled orientation to prevent water flow to said plurality of spray nozzles;
wherein said installation unit having at least a pair of mounting legs for mounting said longitudinal spray bar and said plurality of spray nozzles elevated above the solar panels;
wherein each of said plurality of spray nozzles having a selectable spray nozzle;
wherein said selectable spray nozzle selectable from a spray mist of water and a spray stream of water; and
further wherein said water nozzle control in said enabled orientation flows water to said longitudinal spray bar and said plurality of spray nozzles for spraying water over the solar panels.

9. The solar panel cleaning system of claim 8, wherein said longitudinal spray bar having a material of a schedule 40 PVC pipe.

10. The solar panel cleaning system of claim 9, wherein said plurality of spray nozzles are equidistant from each other.

11. The solar panel cleaning system of claim 9, wherein each of said plurality of spray nozzles selectively positionable laterally along said longitudinal spray bar.

12. The solar panel cleaning system of claim 11, wherein each of said plurality of spray nozzles selectively positionable to an orthogonal distance relative to said longitudinal spray bar.

13. The solar panel cleaning system of claim 11, wherein each of said plurality of spray nozzles having a mounting sleeve for slidable positioning along said longitudinal spray bar.

14. A method for cleaning solar panels, the method comprising the steps of:
providing a longitudinal spray bar extending between a first end and an opposing second end, a plurality of spray nozzles, a water nozzle control, an installation unit, a water supply, and a hose;
positioning said plurality of spray nozzles along said longitudinal spray bar;
connecting said water supply to said hose;
connecting said hose to said longitudinal spray bar;
selectively positioning said water nozzle control between an enabled orientation to allow water flow to said plurality of spray nozzles, and a disabled orientation to prevent water flow to said plurality of spray nozzles;
mounting said longitudinal spray bar to said installation unit, wherein said longitudinal spray bar having at least a pair of mounting legs for mounting said longitudinal spray bar and said plurality of spray nozzles elevated above the solar panels, further wherein each of said plurality of spray nozzles having a selectable spray nozzle; and
setting said water nozzle control in said enabled orientation to flow water to said longitudinal spray bar and said plurality of spray nozzles for spraying water over the solar panels.

15. The method for cleaning solar panels of claim 14, wherein said longitudinal spray bar having a material of a schedule 40 PVC pipe.

16. The method for cleaning solar panels of claim 15, wherein said plurality of spray nozzles are equidistant from each other.

17. The method for cleaning solar panels of claim 15, wherein each of said plurality of spray nozzles selectively positionable laterally along said longitudinal spray bar.

18. The method for cleaning solar panels of claim 16, wherein each of said plurality of spray nozzles selectively positionable to an orthogonal distance relative to said longitudinal spray bar.

19. The method for cleaning solar panels of claim 18, wherein each of said plurality of spray nozzles having a mounting sleeve for slidable positioning along said longitudinal spray bar.

20. The method for cleaning solar panels of claim 19, wherein said selectable spray nozzle selectable from a spray mist of water and a spray stream of water.
